(19) United States
(12) Patent Application Publication
(10) Pub. No.: US 2011/0281044 A1
(43) Pub. Date: Nov. 17, 2011

(54) COMPOSITE STRUCTURES WITH UNIDIRECTIONAL FIBERS

(76) Inventors: Spyros Michail, Livermore, CA (US); Kevin Kenney, San Jose, CA (US); Tommy Tang, Yonghe City (TW); Vinh Diep, Milpitas, CA (US); Shannon Hsueh, Taipei (TW); Dan Hong, Los Altos, CA (US)

(21) Appl. No.: 12/781,761

(22) Filed: May 17, 2010

(51) Int. Cl. B32B 5/26; B32B 5/28; B32B 17/04; B65H 81/00

(52) U.S. Cl. 428/34.5; 156/184; 428/36.4

(57) ABSTRACT

Composite structures may be formed using sheets of unidirectional fiber prepreg. Each of the prepreg sheets may include unidirectional fibers such as glass fibers and a binder such as plastic. The prepreg sheets may be wrapped around the outer surface of a drum. Ring-shaped sections of the wrapped sheets may be cut from the drum to form rings of prepreg layers. The prepreg rings may be placed into a mold cavity of a desired shape. While contained in stack of molds, prepreg rings may be cured by applying heat and pressure. Finished composite structures such as ring-shaped composite structures may be released from the molds following curing. The composite structures may be planar structures that have planar upper and lower surfaces and inner and outer edges. The fibers in the finished composite structures may run parallel to the upper and lower surfaces and parallel to the inner and outer edges.

### BACKGROUND

This relates to composite structures such as structures formed from fibers and binder, and more particularly, to ways in which composite structures can be formed so that unidirectional fibers conform to curves in the structures.

Composites materials such as carbon-fiber composites and fiberglass are widely used in industry. A typical composite structure is formed from woven fibers that are impregnated with a binder. The binder can be cured to form a finished composite structure. The fibers in the structure enhance the strength of the structure.

Composite structures are often stronger, lighter, and more compact than comparable structures formed from materials such as metal or plastic.

Although composites offer advantages, care must be taken to construct composite structures that do not have inherent weaknesses. If formed improperly, composite structures can exhibit weaknesses that make them susceptible to failure during use.

It would therefore be desirable to be able to provide improve composite structures.

### SUMMARY

Composite structures may be formed using sheets of unidirectional fiber prepreg. Each of the prepreg sheets may include unidirectional fibers and binder. Fibers may be formed from glass, plastic, metal, carbon, or other suitable materials. Binder may be formed from plastic, epoxy, or other suitable matrix materials.

The prepreg sheets may be wrapped in multiple layers around the outer surface of a drum until the thickness of the wrapped layers equals a desired width for a ring-shaped composite structure.

Rings of the wrapped prepreg sheets may be cut from the drum using a cutter as the drum is rotated. The prepreg rings may be placed into a mold cavity of a desired shape. For example, if a rectangular ring-shaped composite structure with curved corners is desired, the prepreg rings may be deformed until they fit within the confines of a rectangular groove with rounded corners.

Once the prepreg ring has been inserted into a mold cavity in this way, a set of molds can be stacked. The stacked molds can be heated in a press to cure the prepreg and thereby form the composite structures.

Finished composite structures such as ring-shaped composite structures may be released from the molds following curing. The composite structures may be planar structures that have upper and lower surfaces and inner and outer edges. The fibers in the finished composite structures may run parallel to the upper and lower surfaces and parallel to the inner and outer edges. The upper and lower surfaces of the finished composite structure correspond to the cut edges of the prepreg rings that were removed from the drum. The outer and inner edges of the finished composite structure correspond respectively to the upper and lower surfaces of the outermost and innermost prepreg sheets in the rings.

Further features of the invention, its nature and various advantages will be more apparent from the accompanying drawings and the following detailed description of the preferred embodiments.

### BRIEF DESCRIPTION OF THE DRAWINGS

FIG. 1A is a perspective view of a composite frame structure that has unidirectional fibers that follow the curves in the frame structure in accordance with an embodiment of the present invention.

FIG. 1B is a perspective view of an illustrative case in which the frame structure of FIG. 1A may be used to provide structural support in accordance with an embodiment of the present invention.

FIG. 2 is a top view of an illustrative frame structure of the type shown in FIG. 1B having fibers that run parallel to the edges of the structure in accordance with an embodiment of the present invention.

FIG. 3 is a top view of an illustrative oval composite structure with fibers that run parallel to inner and outer circular edges in the structure in accordance with an embodiment of the present invention.

FIG. 4 is a top view of an illustrative polygonal structure having three sides and three curved corners and having fibers that run parallel to the inner and outer edges of the structure in accordance with an embodiment of the present invention.

FIG. 5 is a cross-sectional side view of an illustrative composite structure of the type shown in FIGS. 1A, 1B, 2, 3, and 4 showing how the composite structure may have fibers that run parallel to the edges of the structure and showing how the composite structure may include binder in accordance with an embodiment of the present invention.

FIG. 6 is a perspective view of a sheet of prepreg material that includes unidirectional fiber and binder in accordance with an embodiment of the present invention.

FIG. 7 is a cross-sectional side view of a drum about which the sheet of FIG. 6 has been wrapped multiple times to form a hoop of composite material in accordance with an embodiment of the present invention.

FIG. 8 is a perspective view showing how a thin ring of composite material may be sliced from the drum using a saw in accordance with an embodiment of the present invention.

FIG. 9 is a perspective view of a ring of material that has been cut from the hoop of material of FIG. 8 in accordance with an embodiment of the present invention.

FIG. 10 is a perspective view of a mold that may be used to form a rectangular frame with rounded corners of the type shown in FIG. 1A from a ring of material of the type shown in FIG. 9 in accordance with an embodiment of the present invention.

FIG. 11 is a cross-sectional side view of the mold of FIG. 10 after the mating upper and lower portions of the mold have been compressed around the ring of material of FIG. 9 in accordance with an embodiment of the present invention.

FIG. 12 is a side view of an illustrative heated press showing how the press may be used to cure workpieces in multiple stacked molds in parallel in accordance with an embodiment of the present invention.

FIG. 13 is a perspective view of a composite structure that has been removed from a mold of the type shown in FIG. 10 after curing the structure using the heated press of FIG. 12 in accordance with an embodiment of the present invention.

FIG. 14 is a perspective view of a portion of a composite structure showing how the composite structure may be formed from numerous layers of prepreg in accordance with an embodiment of the present invention.

FIG. 15 is a flow chart of illustrative steps involved in forming a composite structure using the equipment described in connection with FIGS. 6, 7, 8, 9, 10, 11, and 12 in accordance with an embodiment of the present invention.

### DETAILED DESCRIPTION

Composite structures may be formed by combining fibers with a binder. Composite structures may be used in forming structural members where attributes such as high strength and high stiffness are desired. In some configurations, composite structures may be formed that are transparent to radio-frequency signals. Radio-frequency transparency may be desirable, for example, when a composite structure is being used to form an electronic device or a removable case for an electronic device that transmits and receives radio-frequency signals.

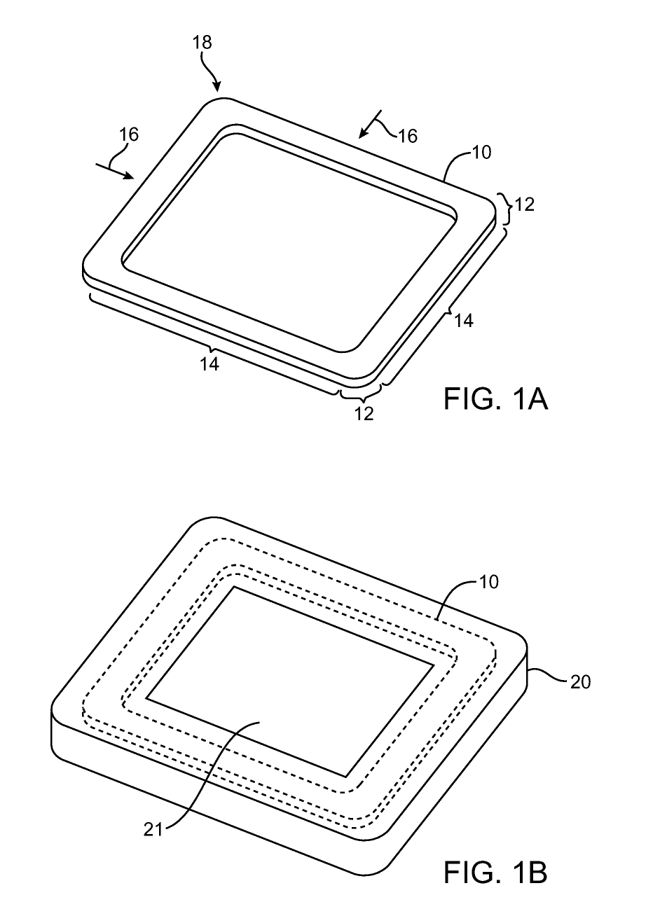

An illustrative composite structure that may serve as a frame member in a removable case is shown in FIG. 1A. An illustrative removable case in which the frame member of FIG. 1A may be used is shown in FIG. 1B. As shown in FIG. 1A, composite frame structure 10 may have a substantially planar shape with inner and outer edges such as a rectangular ring shape. This type of structure may be used, for example, to provide internal structural support to case 20 of FIG. 1B. Case 20 of FIG. 1B may be formed from plastic, fabric, or other flexible materials. Frame 10 may be embedded within case 20 so as to provide a ring of support around central open portion 21 (as an example).

A tablet computer or other electronic device may be placed within case 20 so that its display is visible through opening 21. To ensure that case 20 does not interfere with wireless circuitry within the electronic device, composite structure 10 and the plastic or other material that is used in constructing case 20 may be formed from materials that are transparent to radio-frequency signals (i.e., dielectrics). The arrangement of FIG. 1B is merely illustrative. Composite structures such as composite structure 10 may be used in any suitable application. The use of a rectangular frame structure to support parts of a flexible case for an electronic device is merely illustrative.

In the example of FIG. 1A, composite structure 10 has a generally rectangular ring shape with four straight edge sections 14. Structure 10 may be planar, having a thickness of about 0.1 to 1 mm (as an example). The width of structure 10 may be 2 mm to 10 mm (as an example). Corner sections 12 may be used to join straight edge sections 14. Corner sections 12 may be curved (non-linear).

In composite structures such as the structure of FIG. 1A and other structures with curves, the presence of the curves may sometimes represent a potential weak point in the structure. If fibers run along the length of each edge portion 14, edge portions 14 will be able to withstand side impacts 16. This is because strength in a composite structure is related to fiber orientation. In situations in which fibers run along the length of each edge portion 14, the fibers will be perpendicular to the direction of applied force, providing edge portions 14 with satisfactory strength.

Unless care is taken, however, impacts 18 on curved sections 12 may cause damage to the composite structure. For example, if a composite structure such as composite structure 10 of FIG. 1A were stamped from a bidirectional mesh of fibers, impacts in directions 18 might cause the fibers of the mesh to separate, leading to damage in the structure.

To ensure that curved sections of composite structures such as curved sections 12 of structure 10 in FIG. 1A have sufficient strength, composite structures can be formed from unidirectional fibers that run parallel to the edges of the structure in both straight sections such as sections 14 and in curved sections such as curved section 12.

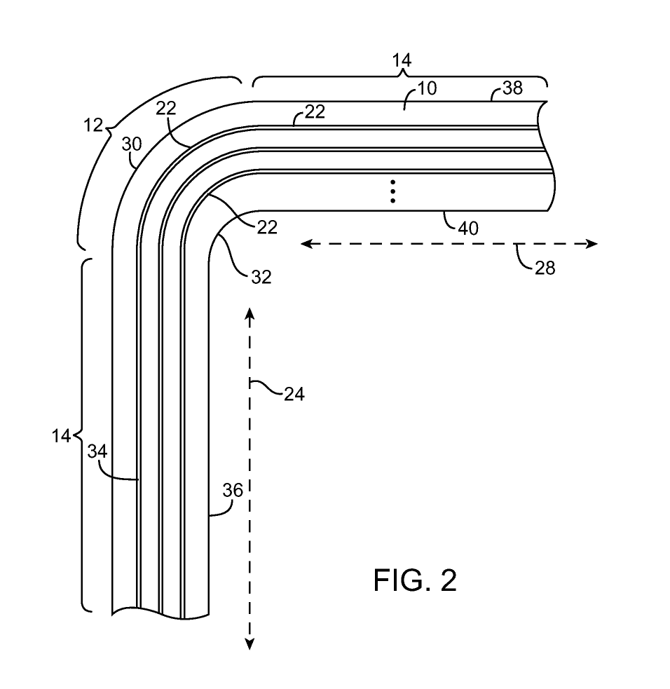

A top view of a corner region of composite structure 10 that shows how the fibers in structure 10 may run parallel to the edges of the structure is shown in FIG. 2. As shown in FIG. 2, composite structure 10 may contain fibers 22. The top edge of structure 10 is a straight section (section 14) having a longitudinal axis that runs parallel to horizontal axis 28. In this portion of structure 10, fibers 22 run horizontally, parallel to horizontally oriented outer edge 38 and horizontally oriented inner edge 40. The left edge of structure 10 is another straight section 14 having a longitudinal axis that runs parallel to vertical axis 24. In this portion of structure 10, fibers 22 run vertically, parallel to vertical outer edge 34 and vertical inner edge 36. Fibers 22 also run continuously in an uninterrupted fashion around curved section 12, parallel to curved outer edge 30 and curve inner edge 32. Because fibers 22 are always perpendicular to the adjacent edges of structure 10 (and to the planar upper and lower surfaces of structure 10), the strength of composite structure 10 is enhanced.

There may be any suitable number of parallel fibers 22 in structure 10. There may be, for example, tens of fibers 22 or hundreds of fibers 22. Fibers that are oriented perpendicular to fibers 22 need not be used.

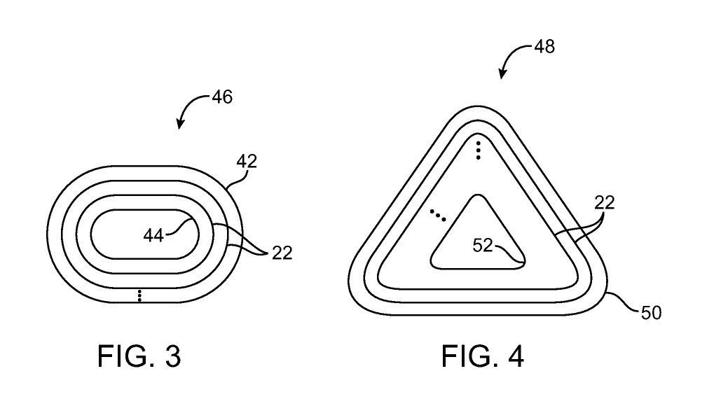

This type of parallel unidirectional fiber arrangement may be used in composite structures of any desired shape. FIG. 3 shows how fibers 22 may run parallel to outer oval edge 42 and inner oval edge 44 in oval ring-shaped composite structure 46 of FIG. 3. FIG. 4 shows how fibers 22 may run parallel to both the straight and curved portions of outer edge 50 and inner edge 52 of triangularly shaped composite ring structure 48.

As with structure 10 of FIG. 1A, structures such as structures 46 and 48 may be substantially planar (as an example). In this type of configuration, the width of the ring-shaped composite structure (i.e., the distance between inner edge 44 and outer edge 42 in FIG. 3 and the distance between inner edge 52 and outer edge 50 of FIG. 4) is typically somewhat larger than the thickness of these structures (i.e., the dimension that is oriented into the page in FIGS. 3 and 4).

Typical ring widths might be, for example, 0.2 mm to 10 mm and typical ring thicknesses might be, for example, 0.05 mm to 5 mm. Other ring widths (e.g., less than 0.2 mm or more than 10 mm) and thicknesses (e.g., less than 0.05 mm or more than 5 mm) may also be used if desired. Moreover, composite structure 10 need not have the shape of a ring. Other structures with curved edges may also be formed in which fibers 22 run parallel to the curved edge of the structure (i.e., in the plane of the structure and parallel to the curved edges). The edges in composite structure 10 may also include sharp angles (i.e., right-angle bends or at least nearly right-angle bends). In general, composite structures with fibers 22 that run parallel to their edges may have any suitable shapes. The shapes shown in FIGS. 1A, 2, 3, and 4 are merely illustrative.

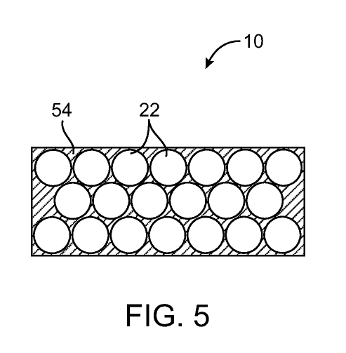

FIG. 5 is a cross-sectional side view of composite structure 10, showing how fibers 22 may be bound together using binder 54. Examples of fibers that may be used to form fibers 22 in composite structure 10 include metal fibers (e.g., strands of steel or copper), glass fibers (e.g., E-glass, S-glass, or quartz), plastic fibers such as polyethylene or polypropylene, etc. Some fibers may exhibit high strength (e.g., polymers such as aramid fibers). Other fibers such as nylon may offer good abrasion resistance (e.g., by exhibiting high performance on a Tabor test). Yet other fibers may be highly flexible (e.g., some fibers may stretch without exhibiting plastic deformation). In general, fibers 22 may be magnetic fibers, conducting fibers, insulating fibers, or fibers with other material properties.

Fibers 22 may be relatively thin (e.g., less than 20 microns or less than 5 microns in diameter—i.e., carbon nanotubes or carbon fiber) or may be thicker (e.g., metal wire). Fibers 22 may be formed from twisted bundles of smaller fibers (sometimes referred to as filaments) or may be provided as unitary fibers of a single untwisted material. Regardless of their individual makeup (i.e. whether thick, thin, or twisted or otherwise formed from smaller fibers), the strands of material that make up fibers 22 may be referred to herein as fibers.

Binder 54 may be formed from a binder material that provides structure 10 with a desired amount of rigidity and strength. Binder 54, which may sometimes be referred to as a matrix, may be formed from epoxy or other suitable materials. These materials may sometimes be categorized as thermoset materials (e.g., materials such as epoxy that are formed from a resin that cannot be reflowed upon reheating) and thermoplastics (e.g., materials such as acrylonitrile butadiene styrene, polycarbonate, and ABS/PC blends that are reheatable). Both thermoset materials and thermoplastics and combinations of thermoset materials and thermoplastic materials may be used as binders if desired.

In applications such as when forming a rectangular ring member for case 20 of FIG. 1B, it may be desirable to use a radio-frequency transparent fiber and binder system. For example, fibers 22 may be glass fibers and binder 54 may be polycarbonate. Other combinations of fiber and binder may be used if desired. For example, fiber 22 may be formed from carbon fibers and binder 54 may be formed from epoxy (as an example).

Composite structures 10 may be formed by winding fibers 22 around the contours of a mold and by filling the mold with binder 54. The binder may then be cured to form a finished part.

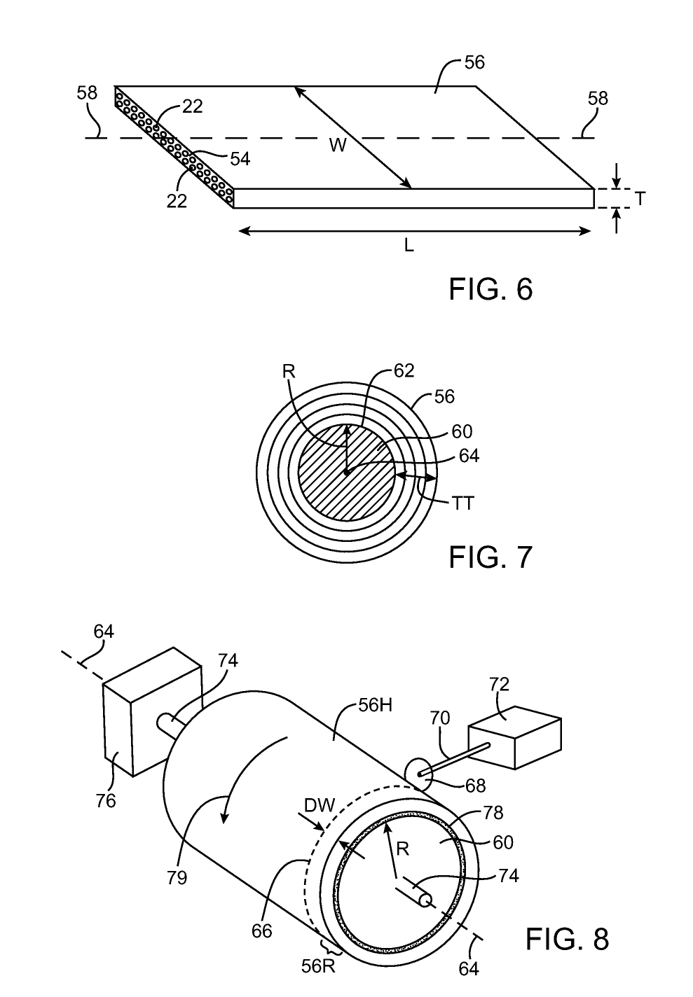

If desired, composite structure 10 may be formed from prepreg (“pre-impregnated”) sheets containing unidirectional fibers using equipment and materials of the type shown in FIGS. 6, 7, 8, 9, 10, 11, 12, and 13.

Initially, a prepreg sheet containing fibers 22 and binder 54 may be formed, as illustrated by sheet 56 of FIG. 6. Prepreg sheet 56 may contain fibers 22 that are unidirectional (i.e., all fibers 22 in sheet 56 may run parallel to longitudinal axis 58 of sheet 56. The binder that is used in sheet 56 may be uncured or partially cured, so that sheet 56 is flexible. Prepreg sheet 56 may have a thickness T of 0.01 mm to 2 mm or may have other thicknesses (e.g., less than 0.01 mm or more than 2 mm). Prepreg sheet 56 may have a width W of 10 to 100 cm, of 10-1000 cm, less than 10 cm, or more than 1000 cm. Length L may be, for example, 1 m, 10 s of meters, 100 s of meters or more. Other lengths may also be used (e.g., lengths of less than 1 m). In general, manufacturing efficiencies may be enhanced by using long sheets of prepreg, provided that the size and weight of the prepreg source material does not become so large as to become unwieldy.

As shown in FIG. 7, prepreg sheet 56 may be wound multiple times around cylindrical outer surface 62 of drum 60 as drum 60 rotates about rotational axis 64. This forms a hollow cylinder (i.e., a hoop) of prepreg material having a total thickness TT and a width W. The inner radius of the hoop is determined by the size of drum radius R.

As shown in FIG. 8, the fibers in the wrapped sheets of prepreg run around the outer surface of the drum, parallel to direction 79 and perpendicular to radial dimension R and rotational axis 64 of drum 60. Once prepreg sheet 56 has been wrapped to a desired thickness, smaller prepreg structures may be formed. The prepreg may, for example, be divided into multiple smaller ring structures.

As shown in FIG. 8, drum may be supported by shaft 74. Motor 76 may rotate shaft 74 so that drum 60 rotates about axis 64. A cutting tool such as rotating saw blade 68 may be positioned against the surface of drum 60 by positioner 72 using arm 70. The outer surface of drum 60 may be coated with a layer of an elastomeric substance such as silicone layer 78 to ensure that blade 68 cleanly cuts through all of the layers of prepreg.

As drum 60 rotates, blade 68 will follow circular cut line 66, thereby separating prepreg ring structure 56R from the rest of the wrapped prepreg layers (i.e., from prepreg hoop portion 56H). Numerous rings of prepreg of desired widths DW may be sliced from drum 60 using this technique.

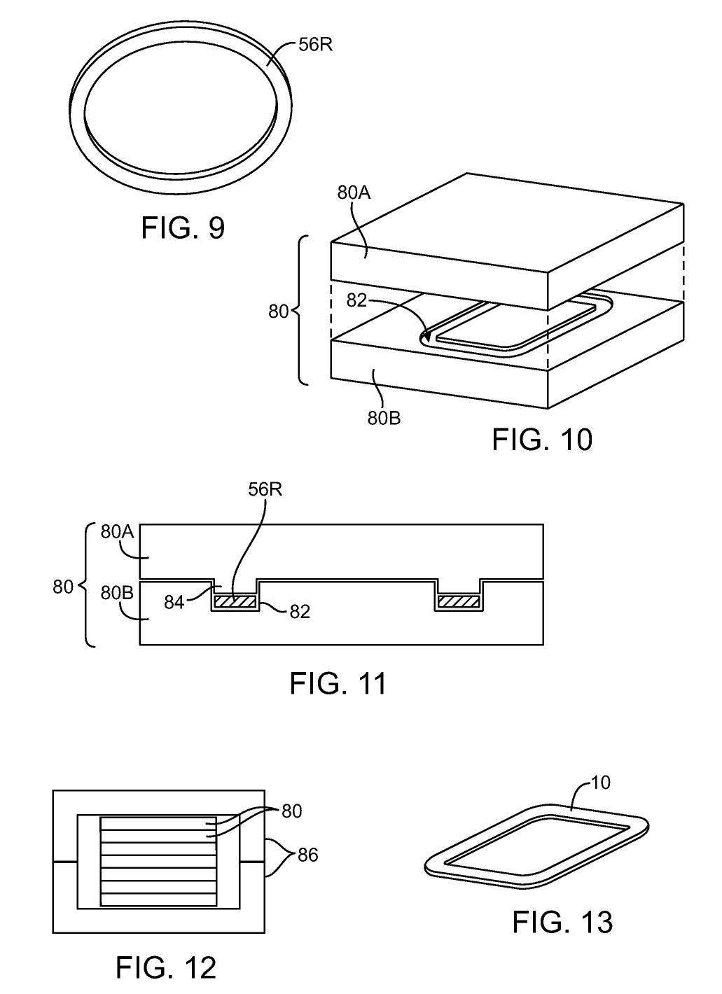

An illustrative prepreg ring 56R that has been removed from drum 60 of FIG. 8 is shown in FIG. 9. Because prepreg ring 56R has not yet been cured, prepreg ring 56R is typically pliable and can be inserted within a mold cavity having the shape of a desired finished composite structure.

An illustrative mold that may be used in curing prepreg ring 56R is shown in FIG. 10. The exploded perspective view of FIG. 10 shows how mold 80 may have upper mold portion 80A and lower mold portion 80B. A groove such as groove 82 of mold portion 80B or other suitable recesses may be formed in mold 80 to receive prepreg ring 56R. As shown in the cross-sectional end view of mold 80 of FIG. 11, upper mold portion 80A may have a protruding portion such as protruding portion 84 that mates with recess 82. When upper mold portions 80A and lower mold portion 80B are joined to form mold 80, a mold cavity is created that forms prepreg ring 56R into a desired shape (e.g., the rectangular ring shape of FIG. 1A).

To cure the prepreg ring 56A, multiple molds 80 may be stacked within a heated press such as heated press 86 of FIG. 12 or other suitable binder heating equipment. Heat and pressure may be applied during curing operations. For example, heated press 86 may heat the prepreg structures in molds 80 to a temperature of about 120° C. for 20 to 30 minutes (as an example). Longer or shorter curing times and lower or higher curing temperatures may be used if desired.

Once the prepreg material within the molds has been cured, molds 80 may be opened and finished parts such as composite structure 10 of FIG. 13 may be removed. Composite structures such as composite structure 10 may then be assembled into finished products (e.g., protective cases for tablet computers, etc.).

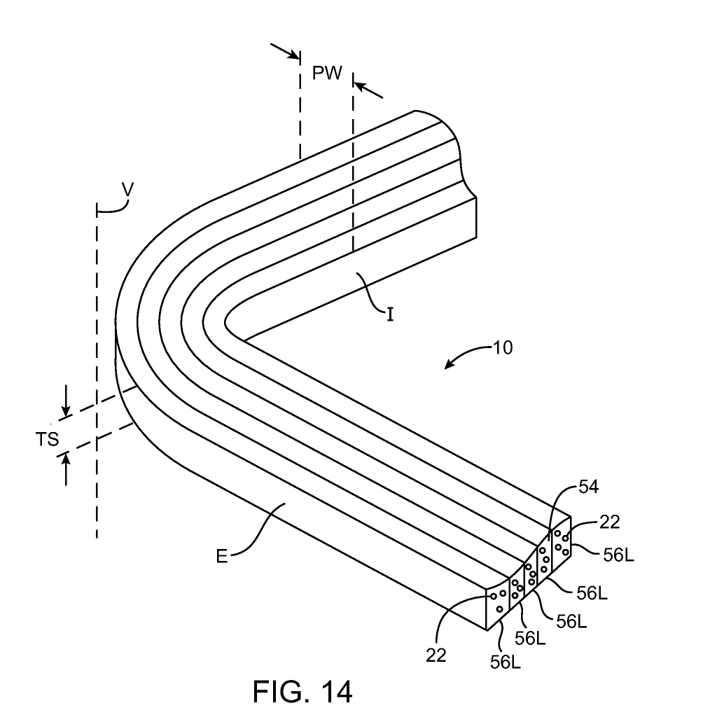

FIG. 14 is a perspective view of a portion of composite structure 10 of FIG. 13 showing how structure 10 may be formed from numerous individual stacked layers 56L of unidirectional prepreg 56. As shown in FIG. 14 outer (upper) edge E of structure 10 is formed by the exposed outer surface of the outermost layer 56L and inner edge I of structure 10 is formed by the exposed inner (lower) surface of the innermost layer 56L. The thickness TS of structure 10, which is measured along vertical axis V, may be substantially equal to the width DW of material that was cut from hoop 56H of FIG. 8. Vertical axis V is perpendicular to a plane containing structure 10 (i.e., vertical axis V is a normal vector to the planar upper surface and planar lower surface of structure 10). In the orientation of FIG. 14, the planar upper surface of structure 10 is visible. The planar upper and lower surfaces of structure 10 are formed from cut edges of sheets 56 (i.e., edges cut by cutter 68 along cut lines such as cut line 66 of FIG. 8).

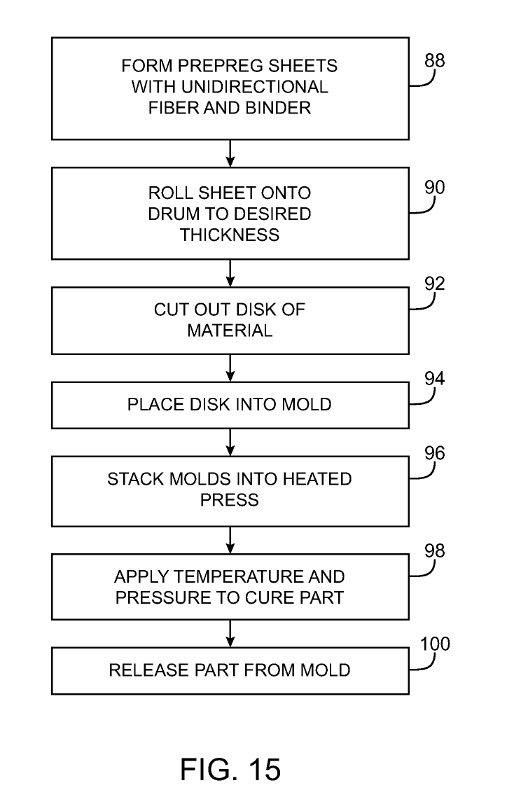

FIG. 15 is a flow chart of illustrative steps involved in forming a composite structure using equipment of the type described in connection with FIGS. 6, 7, 8, 9, 10, 11, and 12.

At step 88, prepreg sheets 56 may be formed by encapsulating a unidirectional collection of fibers 22 within binder 54.

At step 90, numerous layers of prepreg sheet 56 may be wound around drum 60 until a desired total thickness TT is achieved. The total thickness TT of the wrapped prepreg sheets is substantially the same as the desired width PW of structure 10 (i.e., the edge-to-edge dimension of structure 10 shown in FIG. 14).

At step 92, prepreg ring 56R may be removed from drum 60 using cutting equipment such as cutter 68 of FIG. 8.

At step 94, prepreg ring 56R may be placed into groove 82 of mold 80, as described in connection with FIGS. 10 and 11.

At step 96, molds 80 may be stacked within heated press 86.

At step 98, press 86 may apply heat (elevated temperature) and pressure to cure binder 54.

After curing, molds 80 may be opened to release composite structures 10 (step 100).

The foregoing is merely illustrative of the principles of this invention and various modifications can be made by those skilled in the art without departing from the scope and spirit of the invention.

What is claimed is:

1. A composite structure, comprising:
a ring of stacked unidirectional fiber layers, each fiber layer formed from a layer of material having binder and unidirectional fibers and each fiber layer having opposing first and second surfaces, wherein the ring of multiple fiber layers has an outer edge formed by the first surface of an outermost one of the fiber layers and has an inner edge formed by the second surface of an innermost one of the fiber layers.

2. The composite structure defined in claim 1 wherein the ring comprises a planar ring.

3. The composite structure defined in claim 1 wherein the ring comprises a planar rectangular ring with curved corners.

4. The composite structure defined in claim 1 wherein the unidirectional fibers comprise fibers that are transparent to radio-frequency signals.

5. The composite structure defined in claim 1 wherein the unidirectional fibers comprise glass fibers.

6. The composite structure defined in claim 5 wherein the binder comprises plastic.

7. The composite structure defined in claim 1 wherein the binder comprises plastic.

8. A method of forming a composite structure from layers of unidirectional fiber material, each layer of unidirectional fiber having unidirectional fiber and binder, the method comprising:
wrapping multiple layers of the unidirectional fiber material around a drum;
removing a ring of the wrapped layers of unidirectional fiber material from the drum; and
heating the removed ring of the wrapped layers of unidirectional fiber material in a mold.

9. The method defined in claim 8 wherein wrapping the multiple layers of the unidirectional fiber material around the drum comprises wrapping multiple layers of a unidirectional fiber prepreg sheet around the drum.

10. The method defined in claim 9 wherein wrapping multiple layers of the unidirectional fiber material around the drum comprises wrapping the layers of material so that unidirectional fibers in the layers of material run around a circular outer drum surface of the drum and are oriented perpendicular to a rotational axis for the drum and perpendicular to a radial dimension for the drum.

11. The method defined in claim 8 wherein the binder comprises plastic and wherein heating the removed ring comprises heating the plastic.

12. The method defined in claim 8 wherein removing the ring comprises cutting the ring from the drum using a cutter.

13. The method defined in claim 8 wherein heating the removed ring comprises heating the removed ring in a heated press.

14. The method defined in claim 8 further comprising placing the removed ring of the wrapped layers into a cavity in the mold before heating the removed ring.

15. The method defined in claim 14 wherein the mold includes a rectangular groove with curved corners and wherein placing the removed ring of the wrapped layers into the cavity comprises placing the removed ring into the rectangular groove.

16. A planar ring-shaped composite structure having an outer edge and an inner edge, comprising:
multiple sheets of material each of which contains fibers and binder, each sheet having opposing first and second surfaces and opposing first and second cut edges, wherein the sheets of material are stacked so that the outer edge is formed by the first surface of an outermost one of the sheets of material and so that the inner edge is formed by the second surface of an innermost one of the sheets of material.

17. The planar ring-shaped composite structure defined in claim 16 wherein the fibers in each of the sheets of material are unidirectional and the sheets of material comprises unidirectional prepreg sheets.

18. The planar ring-shaped composite structure defined in claim 17 wherein the fibers comprise glass.

19. The planar ring-shaped composite structure defined in claim 16 wherein the binder comprises plastic.

20. The planar ring-shaped composite structure defined in claim 19 wherein the fibers in each of the sheets of material are unidirectional and the sheets of material comprises unidirectional prepreg sheets.
